(19) United States
(12) Patent Application Publication
(10) Pub. No.: US 2015/0206287 A1
(43) Pub. Date: Jul. 23, 2015

(54) Denoising Raw Image Data Using Content Adaptive Orthonormal Transformation with Cycle Spinning

(71) Applicant: Acamar Corporation, Santa Clara, CA (US)

(72) Inventor: Gang Wang, Shanghai (CN)

(21) Appl. No.: 14/525,145

(22) Filed: Oct. 27, 2014

(30) Foreign Application Priority Data
Oct. 25, 2013 (CN) PCT/CN2013/001287

(51) Int. Cl. G06T 5/00; G06T 3/40

(52) U.S. Cl. CPC G06T 5/002; G06T 3/4015; G06T 2207/10016; G06T 2207/30232

(57) ABSTRACT

In a noise reduction process, raw image data in a first domain is transformed into a second domain for noise reduction using a content adaptive orthonormal transformation. In the second domain, noise reduction functions are performed on the image data and then the image data is transformed back to the first domain. In a cycle spinning process, the noise reduction process is repeated with shifted pixel positions and a weighted sum of the processed image data resulting from each cycle is calculated and used to generate a final output image.

### CROSS-REFERENCE TO RELATED APPLICATION

This application claims priority to PCT Application No. PCT/CN2013/001287, entitled “Denoising Raw Image Data Using Content Adaptive Orthonormal Transformation with Cycle Spinning,” filed on Oct. 25, 2013, the entire contents of which are incorporated herein by reference.

### TECHNICAL FIELD

This disclosure relates generally to denoising raw image data.

### BACKGROUND

In image capture systems, raw image data is captured by an image sensor and processed by an image signal processor (ISP) for viewing, compression and further processing. A commonly used raw data format is Bayer data with a Bayer Color Filter Array (CFA) pattern. In the ISP pipeline, the raw image data goes through different stages of processing to achieve image enhancement. After processing, the image data is commonly referred to as processed image data. A common processed data domain is the YUV color space.

Signal processing functions performed by the ISP can be categorized as invertible or non-invertible. The orthonormal transformation is a common invertible function that converts a signal between different coordinate spaces to achieve a more suitable representation. Certain non-invertible functions like truncation, quantization, zeroing, thresholding or complex algorithms can be applied in certain coordinate spaces to achieve enhancement goals like noise reduction.

Noise reduction is a key signal processing function that is used often to improve image performance, especially for images captured under low light conditions. Improving the image signal-to-noise ratio and preserving the image signal integrity under low light conditions has significant value for applications that routinely operate under dark conditions without effective accessory lighting, operations that need to run under dark in covert mode and operations that prefer passive monitoring for a variety of reasons such as product life time, reliability and energy savings.

Conventional noise reduction methods either focus on the processed data domain such as YUV color space, or use transformations that have a predefined dictionary, such as discrete cosine transform (DCT), wavelet, etc. Due to computational complexity, a comprehensive iterative process is not used except in limited multi-pass operation, significantly limiting noise reduction performance in software simulation and in hardware implementation.

### SUMMARY

In a noise reduction process, raw image data in a first domain is transformed into a second domain for noise reduction using a content adaptive orthonormal transformation. In the second domain, noise reduction functions are performed on the image data and then the image data is transformed back to the first domain. In a cycle spinning process, the noise reduction process is repeated with shifted pixel positions and a weighted sum of the processed image data resulting from each cycle is calculated and used to generate a final output image.

In some implementations, a method comprises: (a) receiving image data in a first domain; (b) transforming the image data to a second domain using a content adaptive orthonormal transformation; (c) applying one or more noise reduction functions on the transformed image data; and (d) transforming the image data with reduced noise back to the first domain. In some implementations, where the image data is a block of pixels, the method further comprises: (e)
shifting positions of pixels in the block horizontally and vertically; (f) cycling through steps (b)-(d) using the block of shifted pixels and calculating a weighted sum of the blocks resulting from step (f).

In some implementations, a system comprises: an image sensor; one or more processors coupled to the image sensor; memory coupled to the one or more processors and configured to store instructions, which when executed by the one or more processors, causes the one or more processors to perform operations comprising: (a) receiving image data in a first domain; (b) transforming the image data to a second domain using a content adaptive orthonormal transformation; (c) applying one or more noise reduction functions on the transformed image data; and (d) transforming the image data with reduced noise back to the first domain. In some implementations, where the image data is a block of pixels, the method further comprises: (e)
shifting positions of pixels in the block horizontally and vertically; (f) cycling through steps (b)-(d) using the block of shifted pixels and calculating a weighted sum of the blocks resulting from step (f).

Particular implementations disclosed herein provide one or more of the following advantages: 1) improved signal-to-noise ratio and signal integrity for images captured under low lighting conditions; 2) reduced computational complexity; and 3) adaptable to existing camera systems, data formats and codecs.

### BRIEF DESCRIPTION OF THE DRAWINGS

FIG. 1 illustrates a Bayer filter pattern.

FIG. 2 is a conceptual diagram illustrating an image processing pipeline for denoising raw image data.

FIG. 3 is flow diagram of a process for denoising raw image data.

FIG. 4 is a flow diagram of an example noise reduction step of the process shown in FIG. 3.

FIG. 5 is a flow diagram of an example cycle spinning step of the process shown in FIG. 3.

FIG. 6 is a block diagram of example camera system that implements the features and processes described in reference to FIGS. 1-5.

### DETAILED DESCRIPTION

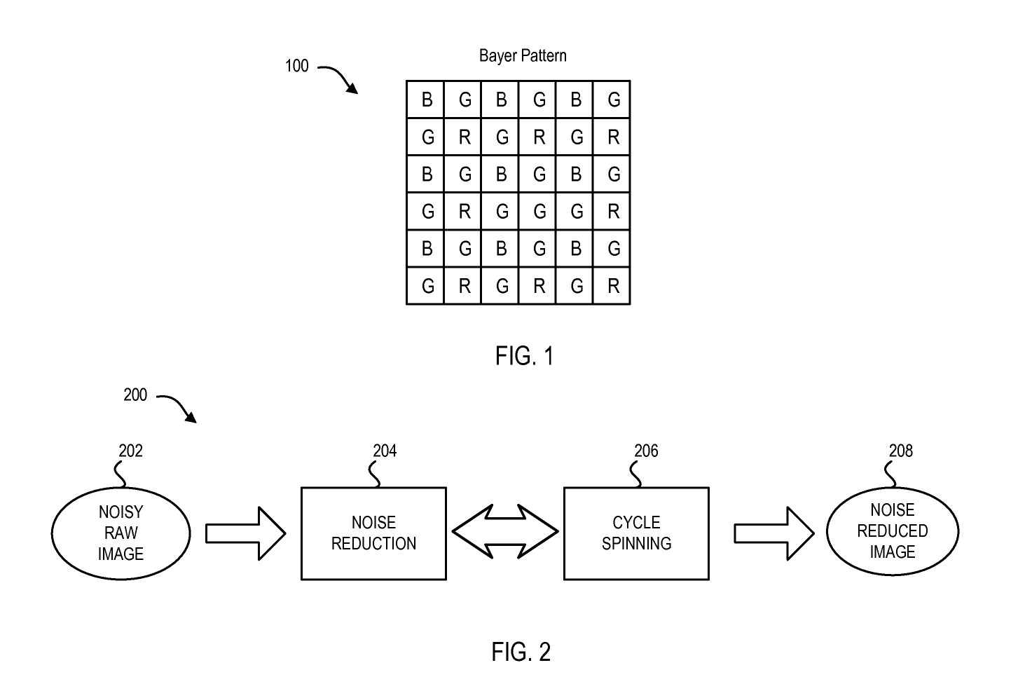

FIG. 1 illustrates a Bayer filter pattern 100. Bayer filter pattern 100 is used for the matrix of a charge-coupled-device (CCD) or complimentary metal-oxide-semiconductor (CMOS) sensor chip in a digital still or video camera. More pixels are dedicated to green than to red and blue, because the human eye is more sensitive to green. The Bayer filter pattern is a color filter array (CFA) that arranges Red Green Blue (RGB) color filters on a square grid of photo-sensors. The Bayer filter pattern is used in many single-chip digital image sensors used in digital cameras, camcorders, and scanners to create a color image. The filter pattern is 50% green, 25% red and 25% blue. When only one array of sensors is used, the additional green pixels produce a better color image. In a three-chip digital video camera, the image may be sent to three separate chips, one each for red, green and blue. A camera raw image file contains minimally processed data from the image sensor of the camera and thus can have a Bayer data pattern, which can be further processed by an image signal processor (ISP) to remove noise as described in reference to FIG. 2.

FIG. 2 is a conceptual diagram illustrating an image processing pipeline 200 for denoising raw image data. Image noise is an undesirable by-product of image capture that adds spurious and extraneous information. Image noise is random variation of brightness or color information in images and is usually an aspect of electronic noise. Image noise can be produced by the sensor and circuitry of the digital camera.

Referring to FIG. 2, an image processing pipeline 200 includes noise reduction 204 and cycle spinning 206. The image processing pipeline 200 can be applied successively to macroblocks of the noisy image data, which has been Bayer (RGB) filtered as described in reference to FIG. 1. Image data that has been filtered by other types of CFAs can also be used, such as RGBW (Red, Green, Blue, White) or CGYM (Cyan, Green, Yellow, Magenta). The raw image data can be generated by a CCD, CMOS sensor or any other image capture device. In some implementations, the macroblock can have a size of n×n, where n is a positive integer equal to 2^{N}, where N is a positive integer less than or equal to 5. Some examples of suitable macroblock sizes are 16×16 and 32×32, but any suitable size can be selected based on the application and the desired operating speed.

A macroblock parsed from noisy raw image data 202 (macroblock of pixels) is transformed into a second domain using a content adaptive orthonormal transformation. A suitable transform is a transform that uses matrix decomposition or factorization (e.g., Cholesky, Single Value Decomposition (SVD), Schur, QR, RRQR, Jordan). Transforming the block of pixels into the second domain decouples noise components from the information bearing image signal. The noise components can then be more easily filtered out without negatively impacting the information bearing image signal, resulting in an increase in the signal-to-noise ratio (SNR) of the image signal.

For example, a content adaptive orthonormal transformation that uses matrix decomposition can decompose the image data along n eigenvectors, such that the noise components are mostly directed along certain eigenvectors and have magnitudes represented by eigenvalues. The eigenvalues of the noise components can be zeroed out or otherwise modified to reduce the noise components. After denoising the image signal, the macroblock can be inverse transformed back to the first domain (raw image domain) and stored in memory for use in cycle spinning 206. The above process is performed on each macroblock of the image until the total number of macro blocks is exhausted. The processed macroblocks can then be assembled back into an image.

Cycle spinning 206 is applied to the re-assembled image. Cycle spinning 206 includes pixel shifting the pixels in the image, horizontally and vertically by m pixels (e.g., 1 pixel). After each pixel shift cycle, the pixel shifted image is subjected to noise reduction 204. The resulting inversely transformed, denoised re-assembled image is included in a weighted sum calculation. That is, for each pixel shifted image, noise reduction 204 is performed and the result is included in a running weighted sum. The running weighted sum of each processed pixel shifted image is the final noise reduced output image.

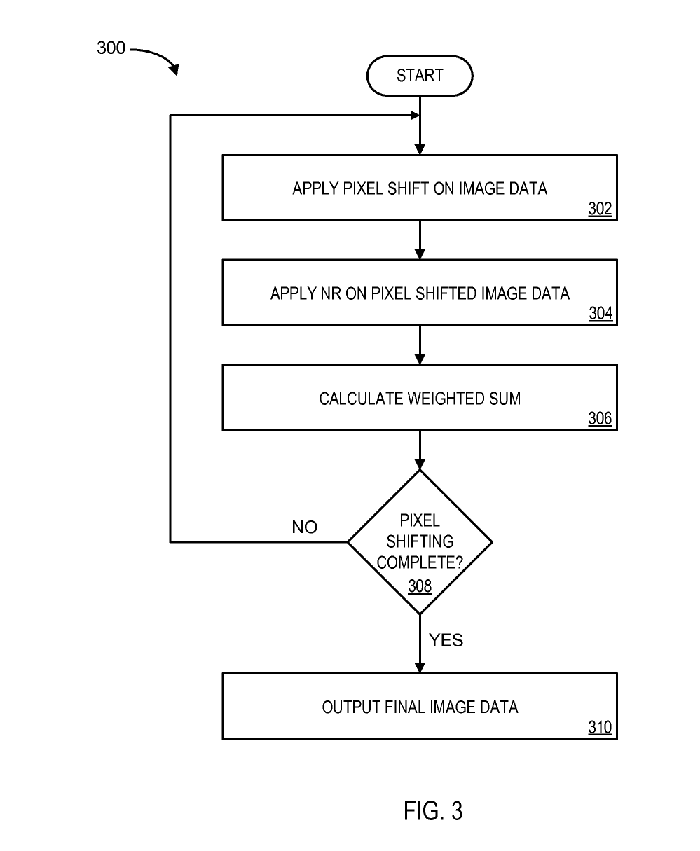

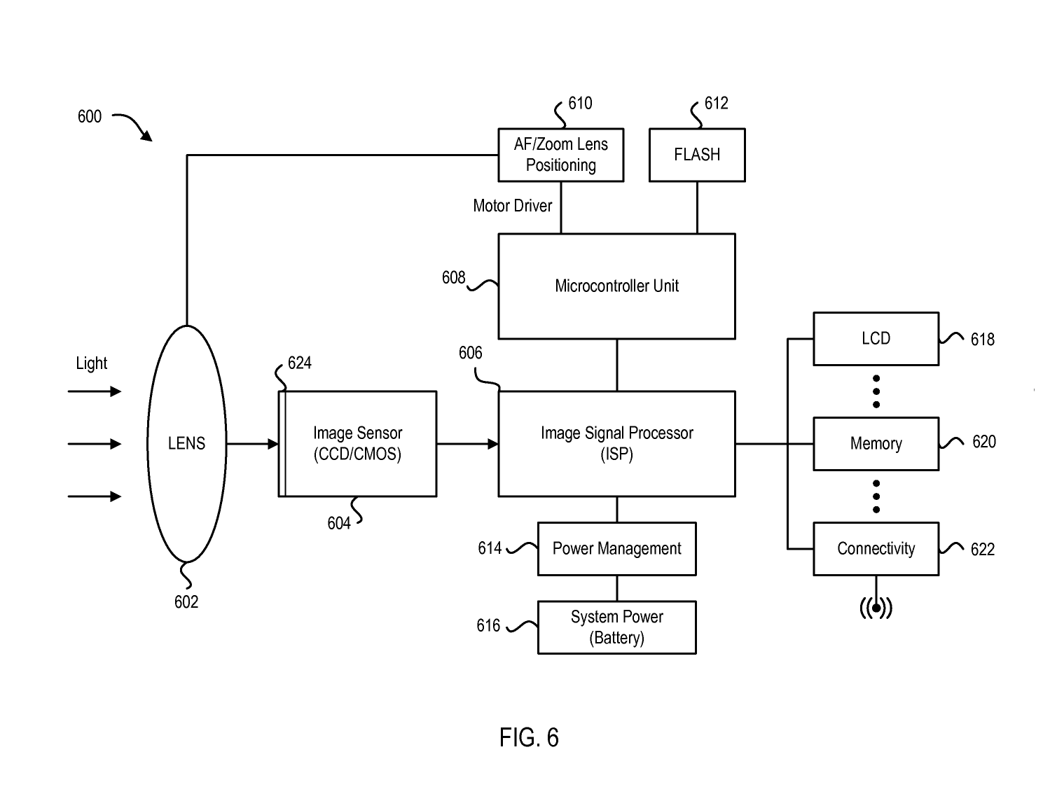

FIG. 3 is flow diagram of a process 300 for denoising raw image data. Process 300 can be implemented by the camera system shown in FIG. 6. In FIG. 3, it is assumed that a first raw image S_{1,1} has been already processed by step 304.

In some implementations, iterative process 300 can continue by applying a pixel shift to the image data (302). In some implementations, the positions of the pixels in the image are shifted in horizontal and vertical directions. After the pixel shift step (302), noise reduction is applied to macroblocks of the pixel shifted image (304). The noise reduction step (304) can include transforming the macroblock of image data from a first domain (e.g., raw image data format) to a second domain using a content adaptive orthonormal transformation, which decouples noise from the information-bearing image signal. One or more denoising functions or filters can be applied to the transformed macroblock to remove or reduce the isolated noise components resulting from the transformation. The denoised macroblock can then be inverse transformed back to the first domain and included in a weighted sum calculation of denoised, pixel shifted images (306).

In some implementations, at the noise reduction step (304) multiple transformations on the macroblocks of the image data can be performed using different content adaptive orthonormal transformations (e.g., DCT, SVD). The transformations can be applied sequentially or in parallel (e.g., using parallel processing techniques and multicore processors) and the resulting reduced noise levels resulting from each transformation of image data can be determined. The cycle spin step (306) can then be executed based on the determined noise levels. For example, the determined noise levels can be averaged and a weight matrix can be selected based on the averaged noise levels for use in the weighted sum calculation of step (306), as described further below.

Process 300 determines (308) that a defined number of pixel shifts has been exhausted (308). If exhausted, process 300 transitions back to step (302); otherwise, process 300 is complete and the weighted sum image can be stored in memory where it can be accessed for further processing.

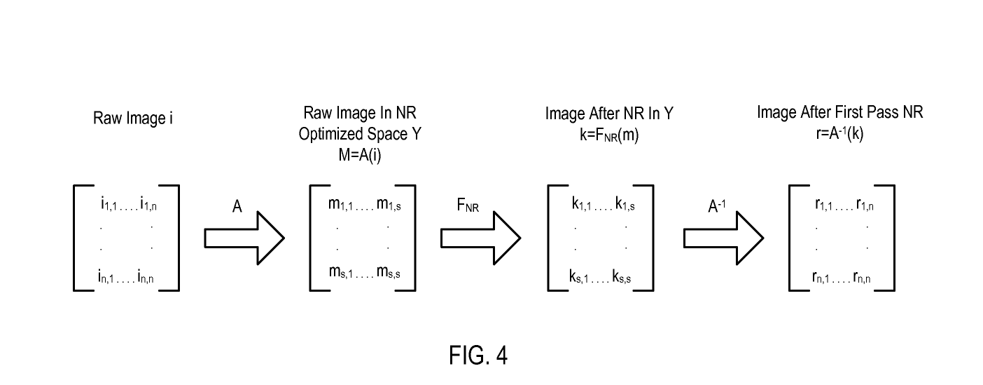

FIG. 4 is a flow diagram of an example noise reduction step of the process shown in FIG. 3. In mathematical terms, the steps of noise reduction process 200 can begin by deriving a content adaptive orthonormal transformation A from an original image i. The transformation A can be performed on macro blocks of the image in the Bayer domain, such that the output is m=A(i). In this new domain (new coordinate space), where noise and signal are significantly decoupled, the noise component can be removed by applying the function F_{NR}, k=F_{NR} (m)=F_{NR} (A(i)). The signal r in the original raw image domain can recovered by taking the inverse transformation A⁻¹ given by

r=A⁻¹(k)=A⁻¹(F_{NR}(A(i))). [1]

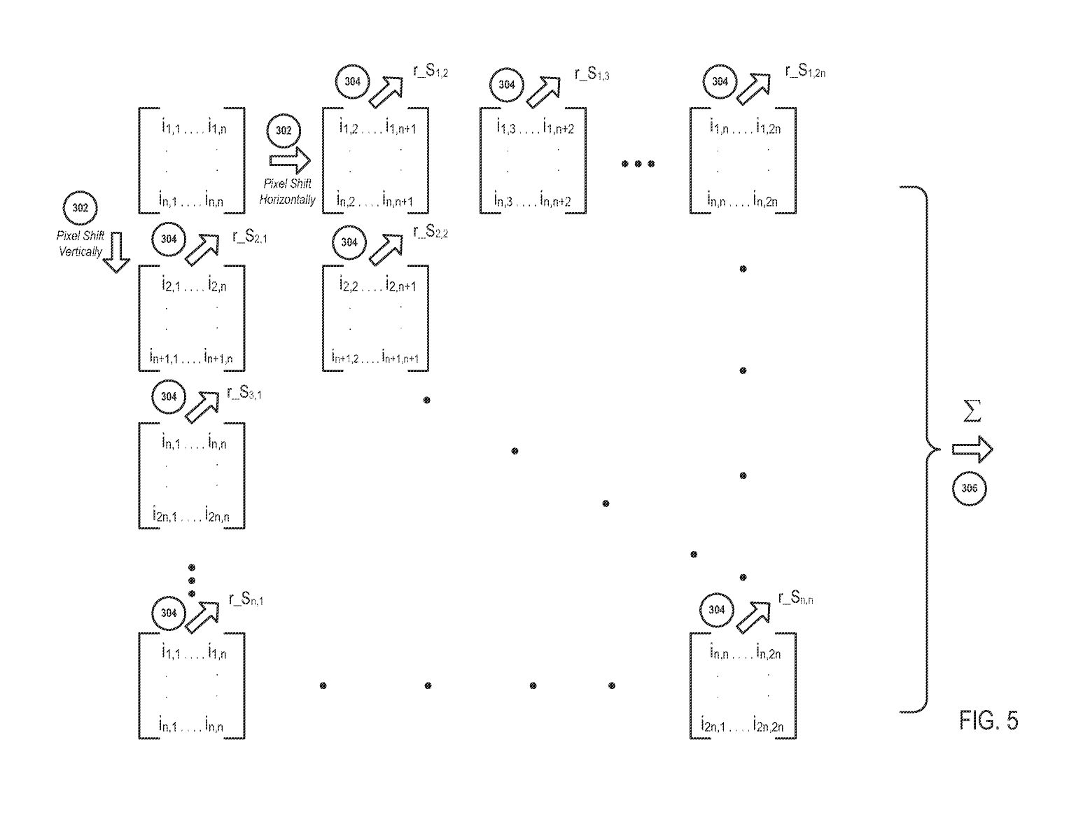

FIG. 5 is a flow diagram of an example cycle spinning step of the process shown in FIG. 3. A cycle spinning process can be performed on the recovered signal r for further noise reduction to produce a final output o given by

o=F_{CycleSpinning}(r)=Σ_{x,y} w_{x,y}*r_{—}S_{x,y}, [2]

where x=1, . . . , n; y=1, . . . , n, n is the size of the macroblock, r_S_{x,y} indicates the pixel shifted image from the original image r and r_S_{1,1} is the original image. r_S_{x,y} is the shifted image with horizontal shifts of (x-m) pixels and vertical shifts of (y-m) pixels, m is the number of pixels and w_{x,y} is the corresponding weight of the shifted image after going through noise processing. The weight matrix can be selected based on the type of transformations selected, the application, noise levels or any other suitable selection criteria. In some implementations, the matrix elements can be floating point numbers in the range of 0.0 and 1.0. In some implementations, the weight matrix is selected based on an average of noise levels resulting from applying multiple different content adaptive orthonormal transformations during the noise reduction process, described in reference to FIG. 4. In some implementations, the dimension in the first space can be the same as the dimension in the second, noise optimized space (e.g., s=n). In other implementations, the dimensions of the first and second space can be different (s>n).

The following is an example of the pseudo-code of the process 300 described above.

NoiseReductionProcessing( ) {

Derive content adaptive orthonormal transformation A
for each macroblock i_b {

| | |
|---|---|
| do { | // noise reduction processing |

r_b = C(i_b) = A⁻¹ (F_{NR} (A(i_b)))

}

}
Reconstruct full processed image from processed macroblocks r_b

}
CycleSpinning( ) {

for each pixel position shift {

NoiseReductionProcessing( ) // Have image with each pixel

shift position go through noise reduction processing

}
Take weighted sum of the above output of all shifted pixel positions

}

FIG. 6 is a block diagram of example camera system 600 that implements the features and processes described in reference to FIGS. 1-5. For example, camera system 600 can be a surveillance camera that is capable of operating in low light conditions. Camera system 600 can also be a camcorder or digital camera (e.g., a DSLR camera).

In some implementations, camera system 600 can include lens 602, image sensor 604 (e.g., CCD, CMOS), ISP 606, microcontroller unit 608, Auto Focus(AF)/zoom lens positioning module 610, flash memory 612, power management module 614, system power 616, LCD monitor 618, removable memory 620 (e.g., memory card) and connectivity (e.g., wireless transceiver). Camera system 600 can include additional components which have been left out for clarity, such as mirrors for focusing light from lens 602 to image sensor 604 and a view finder (not shown).

In some implementations, the features and processes described in reference to FIGS. 2-5 can be implemented as software or firmware instructions which are executed by ISP 606. Light reflected from an object is focused by lens 602 on image sensor 604. Image sensor 604 can include CFA 624 (e.g., Bayer filter). The raw image data output by image sensor 604 is processed by ISP 606, which includes denoising the image data as described above. Microcontroller unit 608 communicates with ISP 606 and manages the various functions of camera system 600, such as providing a motor driver signal to servo motor for AF/zoom positioning module 610. Instructions for microcontroller unit 608 can be stored in flash memory 612.

If camera system 600 is a camcorder, LCD monitor 618 may be included for allowing a user to playback video and provide inputs to a menu system for changing functionality of camera system 600. Removable memory 620 (e.g., SDK card) can be used to store digital images and video. Connectivity 622 allows the camera to communicate with remote equipment. For example, a wireless transmitter or network connection can be used to transmit image data to the remote equipment. A surveillance camera could use the wireless transmitter to transmit live video to a remote monitoring station where it can be stored and further processed.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A method comprising:
(a) receiving image data in a first domain;
(b) transforming the image data to a second domain using a content adaptive orthonormal transformation;
(c) applying one or more noise reduction functions on the transformed image data; and
(d) transforming the image data with reduced noise back to the first domain,
where the method is performed by one or more hardware processors.

2. The method of claim 1, where the data is raw image data having a Bayer data pattern.

3. The method of claim 1, where the content adaptive orthonormal transformation uses matrix decomposition.

4. The method of claim 3, where applying one or more noise reduction functions on the transformed image data includes zeroing out or modifying a number of eigenvalues of eigenvectors resulting from the matrix decomposition that represent noise.

5. The method of claim 1, where the data is a block of pixels and the method further comprises:
(e) shifting positions of pixels in the block horizontally and vertically; and
(f) cycling through steps (b)-(d) using the block of shifted pixels.

6. The method of claim 5, further comprising:
calculating a weighted sum of the blocks resulting from step (f).

7. The method of claim 6, where steps (a) through (f) terminate when a defined number of pixel shifts in the block is exhausted.

8. The method of claim 1, where the image capture device is an image sensor in a video surveillance camera.

9. The method of claim 1, where the image data is received as a n×n macroblock of a digital image, where n is a positive integer equal to 2^{N}, where N is a positive integer less than or equal to 5.

10. The method of claim 1, further comprising:
at step (b), performing multiple transformations on the image data using different content adaptive orthonormal transformations;
determining noise levels resulting from each transformation of image data; and
performing step (c) based on the determined noise levels.

11. The method of claim 10, where performing step (c) based on the determined noise levels comprises:
averaging results of the transformations; and
suppressing noise based on the averaged results.

12. A system comprising:
an image sensor;
one or more processors coupled to the image sensor;
memory coupled to the one or more processors and configured to store instructions, which when executed by the one or more processors, causes the one or more processors to perform operations comprising:
(a) receiving image data in a first domain;
(b) transforming the image data to a second domain using a content adaptive orthonormal transformation;
(c) applying one or more noise reduction functions on the transformed image data; and
(d) transforming the image data with reduced noise back to the first domain.

13. The system of claim 12, where the data is raw image data having a Bayer data pattern.

14. The system of claim 12, where the content adaptive orthonormal transformation uses matrix decomposition.

15. The system of claim 14, where applying one or more noise reduction functions on the transformed image data includes zeroing out or modifying a number of eigenvalues of eigenvectors resulting from the matrix decomposition that represent noise.

16. The system of claim 12, where the image data is a block of pixels and the operations further comprise:
(e) shifting positions of pixels in the block horizontally and vertically; and
(f) cycling through steps (b)-(d) using the block of shifted pixels.

17. The system of claim 16, further comprising:
calculating a weighted sum of the blocks resulting from step (f).

18. The system of claim 17, where steps (a) through (f) terminate when a defined number of possible pixel shifts in the block is exhausted.

19. The system of claim 12, where the system is a video camera and the image capture device is an image sensor.

20. The system of claim 12, where the original image data is received as a n×n macroblock of a digital image, where n is a positive integer equal to 2^{N}, where N is a positive integer less than or equal to 5.

21. The system of claim 12, further comprising:
at step (b), performing multiple transformations on the image data using different content adaptive orthonormal transformations;
determining noise levels resulting from each transformation of image data; and
performing step (c) based on the determined noise levels.

22. The system of claim 21, where performing step (c) based on the determined noise levels comprises:
averaging results of the transformations; and
suppressing noise based on the averaged results.
